(19) United States
(12) Patent Application Publication
(10) Pub. No.: US 2013/0297044 A1
(43) Pub. Date: Nov. 7, 2013

(54) METHOD FOR REDUNDANTLY CONTROLLING PROCESSES OF AN AUTOMATION SYSTEM

(71) Applicants: Eduard Erhardt, Vaihingen (DE); Wilhelm Griesbaum, Kandel (DE)

(72) Inventors: Eduard Erhardt, Vaihingen (DE); Wilhelm Griesbaum, Kandel (DE)

(21) Appl. No.: 13/817,901

(22) PCT Filed: Aug. 10, 2011
(86) PCT No.: PCT/EP11/63753

§ 371 Date: Apr. 22, 2013

(30) Foreign Application Priority Data
Aug. 20, 2010 (DE) 10 2010 039 607.9

(51) Int. Cl. G05B 19/04

(52) U.S. Cl. CPC G05B 19/04
USPC 700/20

(57) ABSTRACT

A method is provided for redundantly controlling process of an automation system having at least two controllers in which each controller consecutively carries out a plurality of task blocks, wherein output data which can be transmitted for carrying out the task blocks is stored in a plurality of work regions exceeding the number of task blocks by one. The work regions contain the respective output data for each of the task blocks. The one additional work region, which is the system work region, contains the output data. The method includes transferring the respective previously synchronized content from the system work region into the work region during the start of a task block in the redundant controllers, updating the content while task block is carried out and, if the updated content is identical, then returning the updated content to the system work region again before the next task block is started.

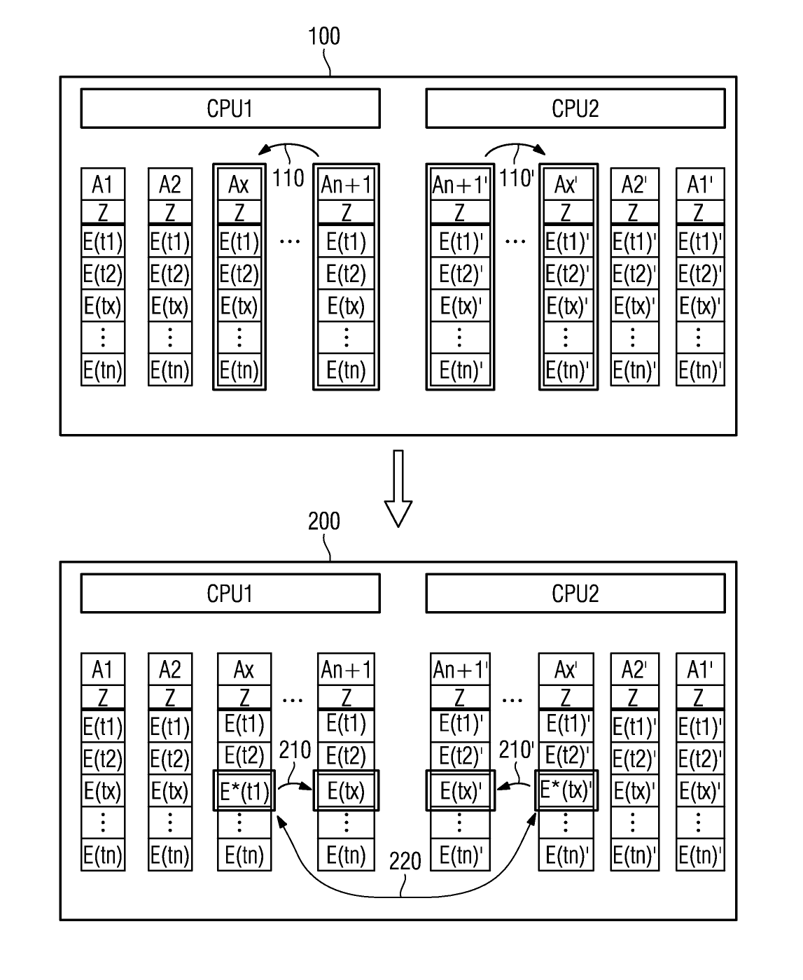

### CROSS REFERENCE TO RELATED APPLICATIONS

This application is the US National Stage of International Application No. PCT/EP2011/063753, filed Aug. 10, 2011 and claims the benefit thereof. The International Application claims the benefits of German application No. 102010039607.9 DE filed Aug. 20, 2010. All of the applications are incorporated by reference herein in their entirety.

### FIELD OF INVENTION

The invention relates to a method for redundantly controlling processes of an automation system.

### BACKGROUND OF INVENTION

Redundant automation systems for reliable operation of a plant or a process are known in many versions. In such systems, the control system is divided into two or more partial systems which carry out individual control and/or regulation tasks. Each of the partial systems has a dedicated control unit, a CPU which is responsible, as the calculating unit, for carrying out the previously projected automation functions. These functions are divided, as machine instructions for the CPU, into a sequence of task blocks—known as ‘tasks’—which process the control units in sequence.

If, for reliability reasons, particular tasks are to be carried out redundantly on a plurality of partial systems or CPUs, said tasks must be carried out synchronously. Otherwise, in the partial systems, access would possibly be made to divergent data, such that different results would be obtained following processing and/or execution of the individual task blocks. Reliable operation of the system to be controlled and/or of the process to be controlled would then no longer be assured.

### SUMMARY OF INVENTION

It is an object of the invention to provide a method for a reliable redundant automation system.

This aim is achieved by means of the features of the independent claim(s), that is, by a method for redundantly controlling processes of an automation system having at least two control units, wherein each control unit performs a number of task blocks one after another, wherein for execution of the task blocks, output data which can be transmitted are stored in a number of work regions which exceeds by one the number of task blocks, the respective work regions each containing the output data for each of the task blocks, wherein the one additional work region, which is the system work region, contains the output data which can currently be transmitted and for execution of a task block is used in each of the control units such that, on starting the task block to be executed, the current content of the system work region is transferred to the work region, at the end of the task block that has been carried out, the output data of the work regions of the at least two control units updated with results from the executed task block are compared with one another and the updated content of said work regions is transferred to the system work regions and, if the content of the work regions for the task block in the control units is identical, the next task block is started.

Since, on starting a task block in the redundant control units, the previously synchronized content is transferred, in each case, from the system work region into the work region, said content is then updated during execution of the task block and subsequently, the updated content—if said content is identical in the redundant control units—is again transferred to the system work region before the next task block is started, a very simple and reliable method for synchronous and consistent, and thus contradiction-free, data maintenance and redundant control in automation systems is achieved. By this means, the passing on of deviating results and thus the continuation of control with deviating output data is precluded. The introduction of a number of work regions exceeding by one the number of task blocks and thus of an additional system work region for the transfer and adoption of output data therefore enables the creation of an automation system with highly available redundancy, which is simultaneously more error-proof and thus more reliable. The method according to the invention therefore ultimately enables the automation functionality to be independent of the system functionality. The tasks for the automation functions can be started at any time, independently of the system, based on updated and consistent data which are also permanently available in the system. Additional test routines for a consistency test of the data are no longer necessary, but rather are bound into the sequence without time delay. It is therefore a very simple method for redundant control by means of which development, testing and maintenance costs can also be reduced.

The method according to the invention is particularly advantageous on use of multicore systems—that is, CPUs with a plurality of processors. When the method is used, the parallel and redundant task sequence on said processors in one core enables particularly high processing speeds and high computational output because the high administrative and coordination effort otherwise required is dispensed with.

Preferably, the updated contents of the work regions are transferred into this system work region during an interrupt block at the end of each task performed. This means that only one interrupt block is still needed per task execution, so that the performance speed can be maximized.

Advantageously, following execution of a task in the redundant control units, a comparison of the updated content of the respective work regions is carried out based on digit sums across the respective content. This digit sum comparison can be made, for example, according to known methods of checksum comparison. Said comparison is available immediately without great calculation effort, which also leads to maximization of the performance speed.

Particularly advantageously, only the updated output data of the work regions are incorporated into the system work regions as updated content, since then only the results are incorporated here for this task and all other content of the work region remains unchanged.

Further advantageous embodiments according to the invention are disclosed in the subclaims.

### BRIEF DESCRIPTION OF THE DRAWINGS

The invention will now be described making reference to a single drawing.

What is shown, highly schematically, is a sequence of a single task execution tx from a number n of tasks t1, t2, tx to tn. Each of the tasks represents a task block with control and machine commands for the automation functions to be controlled.

### DETAILED DESCRIPTION OF INVENTION

At the start of the sequence shown, at a time point 100, for example, following starting up of the automation system or following ending of a prior task execution, the task tx is started, then executed and ended at a time point 200 before, possibly, the next task is started. The execution of the task tx is shown here with only an arrow between 100 and 200. During execution of the task, the individual control commands and/or machine commands of the automation system are converted and implemented in known manner so that performance of a task block therefore need not be shown and described in detail at this point. Rather, what is essential to the invention are the facts that an additional work region—the system work region—is created and this is used at the time points 100 and 200, specifically at the start and end of the execution of each of the task blocks in order to achieve redundant and error-free, and therefore reliable, control of the automation functions.

In the present exemplary embodiment, two control units CPU1 and CPU2 are provided for redundantly controlling the processes of the automation system which, respectively, carry out the previously projected number n of task blocks t1, t2, tx to tn. Output data E(t1) to E(tn) and E(t1)′ to E(tn)′ are assigned to these n task blocks, said output data being stored in n work regions A1 to An and A1′ to An for each CPU. Apart from said n work regions, in each case, an (n+1)th work region is provided as a ‘system work region’ An+1 or An+1′ in the two control units CPU1 and CPU2, containing the output data which currently can be transferred and being used for carrying out the task blocks, as described below using the example of the task block tx. The task tx is started simultaneously in all the CPUs connected into a redundant system, in this case, CPU1 and CPU2. For each task start, the entire content of the system work regions An+1 and An+1′ is copied into the corresponding work regions Ax and Ax′ for the current task tx, as indicated in the figure with reference sign 110 for CPU1 and 110′ for CPU2. Data consistency on copying is ensured by means of a comparison of the transfer counters Z of the system work regions. Said write-counter comparison takes place before and/or after the transfer. If the transfer counters deviate between the system work region An+1 and the work region Ax for the task block tx in CPU1 or between the system work region An+1′ and the work region Ax′ for tx in CPU2 or in the event of a deviation of the transfer counters between the work regions of the two CPUs, the procedure is repeated. If the transfer counters agree, the actual task sequence takes place following provision of the current content in the work region Ax or Ax′, independently of the partner CPUs, that is, without synchronization of the CPUs for the duration of the execution and given command-grained interruptibility without wake-up alarm blocking. This has the effect for the overall sequence that, despite the multitasking functionality and the command-grained interruptibility, a one-task system (no task coordination and no synchronization for the functionality based thereon). At task end, a digit sum is formed across the entire task result and is made available to the partner components for the comparison, as shown in the figure with the reference sign 220.

If the digit sums are the same across the content, under an interrupt block, the task result E*(tx) or E*(tx)¹ is copied into the respective system work region An+1 or An+1′ of CPU1 and CPU2 (reference signs 210 and 210′) and the incremental transfer counter Z in the system work region An+1 or An+1′ is incremented. The next execution block can then be started. Thus each individual task can be started with updated and consistent data in the redundant control units at any required time point.

If the digit sums are different, then the following procedures are conceivable:
a.) placing the digit sums determined into intermediate storage and starting and comparing the execution of the tasks tx again;
b.) as is usual for error-safe systems, breaking off the automation process and placing the automation system into a safe state;
c.) checking the projected tasks and comparing the expected identical digit sums with the different digit sums determined.

The present invention is not restricted to the embodiment described above. Rather, combinations, deviations and enhancements of individual features are conceivable, which can lead to the further possible embodiments of the inventive concept. For example, the system work regions An+1 and An+1′ of the control units CPU1 and CPU2 can be copies of a centrally stored system work region, said centrally stored system work region being replaced, before the next task block to be executed is started, by the current content of the system work regions of both the control units.

What is important in all the embodiments of the method according to the invention is only the localization of the deviation between the redundant control units—whether two, as described above, or a plurality thereof—at the end of each execution block, and the fact that such errors are immediately recognized and therefore, no error results are passed on to the process and no further processing takes place with erroneous values. Therefore the RAM errors which can occur in RAM during very long continuous operation of conventional automation systems individually can also be recognized. The method according to the invention can also be used very easily for shock-free switching-in of redundant control units, because additional control units can be switched in task-specifically.

1-8. (canceled)

9. A method for redundantly controlling processes of an automation system which comprises at least two control units, wherein each control unit performs a plurality of task blocks one after another, wherein for execution of the task blocks, output data which can be transmitted are stored in a plurality of work regions which exceeds by one the number of task blocks, the respective work regions each containing the output data for each of the task blocks, wherein the one additional work region, which is the system work region, contains the output data which can currently be transmitted and for execution of a task block is used in each of the control units, the method comprising:
on starting the task block to be executed, transferring the current content of the system work region to the work region,
at the end of the task block that has been carried out, comparing the output data of the work regions of the at least two control units updated with results from the executed task block with one another,
transferring the updated content of said work regions to the system work regions, and
if the content of the work regions for the task block in the control units is identical, then starting the next task block.

10. The method as claimed in claim 9, further comprising comparing an incremental transfer counter of the current system work regions of the control units before and/or after the transfer.

11. The method as claimed in claim 9, wherein, at the end of the task block being carried out, an incremental transfer counter of the system work regions is compared and incremented.

12. The method as claimed in claim 9, further comprising incorporating the updated contents of the work regions into the system work regions during an interrupt block.

13. The method as claimed in claim 9, wherein the contents are evaluated as being identical if the output data updated with the results of the performed task block are the same in the at least two control units.

14. The method as claimed in claim 13, wherein the output data are the same if the digit sums thereof agree.

15. The method as claimed in claim 9, wherein only the updated output data are incorporated into the system work regions as updated content of the work regions.

16. The method as claimed in claim 9, wherein that the system work regions of the control units are copies of a centrally stored system work region and said centrally stored system work region is replaced before the next task block to be executed is started, by the current content of the system work regions of the control units.
